(19) United States
(12) Patent Application Publication
(10) Pub. No.: US 2015/0254290 A1
(43) Pub. Date: Sep. 10, 2015

(54) SYSTEMS AND/OR METHODS FOR ON-DEMAND REPOSITORY BOOTSTRAPPING AT RUNTIME IN A SCALABLE, DISTRIBUTED MULTI-TENANT ENVIRONMENT

(71) Applicant: Software AG, Darmstadt (DE)

(72) Inventors: Marc Lehmann, Blieskastel (DE); Christoph Wagmann, Bexbach (DE)

(73) Assignee: Software AG, Darmstadt (DE)

(21) Appl. No.: 14/198,298

(22) Filed: Mar. 5, 2014

(51) Int. Cl. G06F 17/30; H04L 29/08; H04L 12/26; H04L 29/06

(52) U.S. Cl. CPC G06F 17/30321; H04L 67/42; G06F 17/30091; H04L 67/30; H04L 43/04

(57) ABSTRACT

Certain example embodiments relate to techniques for dynamically bootstrapping repositories or databases for newly created tenants at runtime in scalable, distributed multi-tenant environments. Repositories are maintained for respective application-tenant combinations. If there is an existing repository for the application and tenant combination involved in an incoming request, the request is responded to using that existing repository. However, if this is not the case, a new repository is created dynamically and at runtime. Bootstrapping is triggered dynamically the first time a client application tries to access the newly created tenant at runtime. This approach advantageously is flexible when it comes to enabling tenant- and application-specific repositories with optional search index mapping (e.g., for searching and/or other purposes).

### TECHNICAL FIELD

Certain example embodiments described herein relate to scalable, distributed multi-tenant environments. More particularly, certain example embodiments described herein relate to techniques for dynamically bootstrapping repositories or databases for newly created tenants at runtime in scalable, distributed multi-tenant environments. In certain example embodiments, the bootstrapping is triggered dynamically the first time a client application tries to access a specific repository related to a newly created tenant at runtime, leading to a flexible approach for enabling tenant- and application-specific repositories with optional search index mapping (e.g., for searching and/or other purposes).

### BACKGROUND AND SUMMARY OF EXAMPLE EMBODIMENTS

Computer applications with database connectivity oftentimes have been designed such that backend components (such as, for example, tables, stored procedures, views, and/or the like), and also the database itself, need to be configured before the start of the applications that use them. For instance, relational databases have been used to provide information to computer applications, and the components of the relational databases typically are designed and created before such applications try to access them. As a result, information about the contents of the databases is needed before a database server can be started. Although this approach can work well in small, single-tenant environments, it can becomes more difficult as complexities are introduced, e.g., by virtue of the size of the application growing and/or its functionality increasing, the number of tenants using the application rising, etc.

One particularly problematic area involves highly distributed and scalable environments, e.g., of the sort oftentimes associated with cloud computing scenarios. In the computer systems architecture world, cloud computing has recently received some attention. Although there are many competing definitions for “cloud computing,” it is fairly well accepted that cloud computing generally involves (1) the delivery of computing as a service rather than a product, and (2) providing shared processing and/or storage resources, software, information, etc., to computers and other devices as an oftentimes metered service over a network (typically the Internet). In a cloud computing environment, end users do not necessarily need to know the physical location and configuration of the system that delivers the services. Applications typically are delivered to end-users as the service, enabling transparent access to the cloud-based resources.

Regardless of whether a cloud computing environment is implemented, it is not uncommon for every tenant in a multi-tenant environment to have its own repositories. These repositories may be used in providing backend database functionality and/or the like. Moreover, the number and type(s) of repositories for a given tenant can vary depending on the applications actually used by that tenant, and if users associated with a tenant want to use a specific function of an application for the first time, an initial process of creating the repositories required for that functionality may be triggered. For instance, an implicated database management system (DMS) may create several repositories for the tenant including, for example, one repository for permanent storage, and perhaps three additional repositories associated with other technical requirements (e.g., for storing metadata, providing a search index, enabling caching functionality, etc.). Further additional repositories for the tenant may need to be created on demand, e.g., when needed by a different part of the application (e.g., an application instance) or another service that uses the application for storing data. Of course, as alluded to above, it will be appreciated that this description could in some implementations apply to each tenant in a multi-tenant system, thereby requiring a large amount of processing during runtime by virtue of the need to create many different repositories for many different tenants, applications, and/or underlying purposes.

In this regard, in a public cloud installation, e.g., where tenants can be created and deleted at virtually any time (for instance, when a customer buys access to a software solution or cancels an existing contract), it would be desirable to react to such events as they occur—even if they occurring during runtime of the associated underlying application. But when a new tenant is created, the backend may not yet be prepared for the tenant and/or the application may not have the information necessary to connect to the repositories of the newly created tenant, e.g., if conventional approaches are leveraged. Thus, it will be appreciated that the dynamic scaling of the database (or more generally, the data storage service) and the use of the same database instance for several tenants and different datasets can be very difficult, particularly if a predefined schema of table structure must be maintained.

In view of the foregoing, it will be appreciated by those skilled in the art that highly distributed and scalable environments, like those associated with cloud computing, can oftentimes present problems because information regarding what is needed for creating and/or maintaining a database (or more generally, a repository) for storing data from specific tenants, applications, and/or the like, generally is not known and in fact is sometimes not knowable, at least at startup time. For instance, it is not always possible to predict when new users may purchase an application, when current users might terminate their use of an application, when users might change tenants (e.g., by virtue of a merger, acquisition, reorganization, etc.), and so on. Similarly, there may be problems associated with changing the schema for differently structured data, creating new tables, starting a new database server, etc. These problems may be manifested in scenarios where, for example, it would be desirable to use the same database for newly created tenants who want to access their databases or repositories from a specific part of an application. Additionally, downtime generally is seen as unacceptable in a public cloud scenario—and it therefore may not be feasible to repeatedly stop and restart an application, e.g., as new components are configured and made available, as new tenants are introduced, etc.

In conventional, single-tenancy architectures, applications and/or application instances generally will access databases or other repositories with predefined structures. Index mappings (e.g., used for searching) will be linked to the repositories. The applications and/or application instances, in turn, will be configured to access exactly these repositories. All these components generally will be “hardwired” in the system and configured before the various components and/or associated services are started. As a result, conventional, single-tenancy architectures generally will implement static, predefined installations and deployment processes. Indeed, as alluded to above, the system oftentimes will need to create repositories that in turn have to be configured with all tables, stored procedures, views, etc., as well as a “hardwired” index mapping for an associated search engine. After that, it becomes possible to configure the applications and/or application instances and start everything in the correct order.

Pitfalls in conventional, single-tenancy architectures can come into play to an even greater extent when scalability and multi-tenancy issues are considered, when it oftentimes is not possible to provide a unique and complete installation for each tenant, and/or in other situations. Further, conventional, single-tenancy installations generally involve static and disjunct subsystems that are not scalable and/or have difficulties when attempting to scale. Unique installations generally will have no connection to one other, thereby implying that the components used in a first environment cannot be used in another installed environment, e.g., in order to handle failures of services of another installation. Yet the ability to provide failover mechanisms oftentimes is an important feature in cloud computing scenarios, and the limited ability to provide them can be problematic. Another problem involves each installation only being used for one application at a time. For instance, if two different applications and/or application instances want to use an application for storing data, it may be necessary to provide one installation for each application or application instance.

FIG. 1 is an example single-tenancy architecture. As shown in FIG. 1, for a first installation (Installation A), an application instance (e.g., a web application instance) 100a attempts to access a predefined repository or database 104a. The information needed for accessing this database 104a was configured and stored as application settings before the application instance 100a was started. At the backend side 102a in Installation A, everything is properly configured for a specific tenant and a specific application instance (in this case, application instance 100a). This predefined configuration is “hardwired” in the system and cannot be dynamically changed for another tenant, application, and/or application instance. Thus, it will be appreciated that each application/tenant (or application instance/tenant) combination is provided with its own installation settings to connect to the backend and, in the FIG. 1 example, separate Installations A and B are provided. In this regard, a parallel structure to that described in connection with Installation A is provided for Installation B, with like reference numerals having the “a” and “b” suffixes being provided for, and designating like components in, Installations A and B respectively.

Referring once again to Installation A, the database 104a is configured with a static repository. Thus, it can only be used for one application instance (in this case, application instance 100a) and one tenant. If another application instance (e.g., application instance 100b) and/or tenant would like to use the web application, it would need another complete installation (e.g., as in Installation B) that is unique to that combination.

To be able to search documents and/or objects stored in the repository 104a, an index mapping 106a that is configured to match the repository 104a is provided and configured for a specific application/tenant (or application instance/tenant) combination. The naming convention for the search index 108a is static and non-unique, and it only works with one repository 104a and provides one searchable index 108a. As shown in FIG. 1, there is only one search index per installation. The index 108a is updated every time a new document is stored to the permanent repository 104a, e.g., by reading a “changes feed” using a search plug-in for metadata and an indexing tool for the full-text search.

There currently are three main approaches to enabling multi-tenancy and to solving the need for preconfigured databases (e.g., in arrangements where relational databases and/or the like are used). These main approaches involved shared nothing, shared database, and shared table architectures. Unfortunately, these approaches do not fit the needs of complex, multi-tenant environments with heavy user bases because they tend to involve manual steps and tend to not scale well. Each of these approaches will be described in greater detail below.

First, in a shared nothing approach, one database is used for each tenant. Using one database for each tenant implies a need for some external scripting, e.g., if one tries to enable new databases for newly created tenants. The control of the data source, however, is outside the application itself and cannot dynamically scale because there is no knowledge of the demands and/or resources available. In a related vein, load balancing may not be possible, e.g., because the application cannot assign a heavy load tenant to a database instance that is capable of handling more traffic. Thus, every tenant is provided with exactly the same database in this scenario, regardless of whether there a few users or thousands of users using a particular service. Although this approach could be improved by setting up database clusters, such an approach leads to more complexity and even further reduces the flexibility to react dynamically to changes of the data structure, database usage of the application, etc.

Second, in a shared database approach, one database is shared and different schema namespaces are used. This approach isolates the data from the tenants, but one still needs to create everything “from scratch” and outside the application itself. In most cases, this unfortunately leads to downtime, the reliance on and heavy utilization of external scripts, a database administrator taking these and/or other actions manually, etc. Indeed, the conventional computer science wisdom is that it is bad practice to undertake these steps automatically from within the application, e.g. by using a Hibernate connector or the like. As a result, this approach oftentimes brings with it heavy reliance on difficult to maintain techniques like reflection (e.g., using a tool like Reflection available from Attachmate), the use of abstraction frameworks like Hibernate (available from Red Hat), and/or the like, even though such techniques are not designed to be used in these ways.

In addition, in a shared database approach, it oftentimes is difficult to use a full-text index for every tenant, separated from the index of every other tenant, because the database oftentimes uses only one index per database. To achieve the desired functionality, one may need to further adapt the code, e.g., to enable full-text searches over specific datasets for the different tenants, while potentially staying aware of how each index is shared with other tenants (e.g., in order to avoid potentially “leaking” information across customers, etc.). There also exists the same or similar problems regarding the use of predefined schemas, the inability to react dynamically (including the inability to be downwardly compatible to changes), etc., without changing the whole data layer and/or database schema.

Third, an approach using shared tables (e.g., where different prefixes are used to distinguish between data of different tenants) might be an easy-to-implement approach, but could also be quite dangerous. When using a shared table approach, the data of all tenants is stored in the same table. Different prefixes may, for example, be used to distinguish between data of different tenants. Unfortunately, however, this approach may be problematic in terms of security because access rights in database systems usually can only be specified on a table level and not, for example, based on table rows. Data isolation therefore may possibly occur at the application level and, as a result, it could easily be the case that a tenant sees the data of another tenant. Additionally, this approach could make it difficult to allow tenant specific extensions to the database schema, as doing so likely would affect all tenants. Resource contention could also be a problem. Moreover, the pitfalls of the shared nothing and shared database approaches described above are likely to exist here, as well.

Other approaches have been tried. For example, in a paper entitled “ProRea-Live Database Migration for Multi-tenant RDBMS with Snapshot Isolation,” the authors describe an approach for the migration of multi-tenant databases, combining proactive and reactive database migration approaches. They review commonly used multi-tenancy models and compare them concerning database migration concepts. Yet this paper does not describe a bootstrapping process, nor does it introduce a new multi-tenancy model.

As another example, in a paper entitled “ElasTraS: An Elastic, Scalable, and Self-Managing Transactional Database for the Cloud,” the authors describe a distributed transaction system for multi-tenant environments using a shared database process and a process for migration of running transactions across database instances. It does not, however, cover the process of repository bootstrapping or configuration.

U.S. Pat. No. 8,122,055 (which is hereby incorporated by reference herein in its entirety) describes a mechanism for coordination of a multi-tenant environment. A shared database is used to store information about configuration and location of unshared tenant databases as well as cross tenant data. This patent in essence provides an extension of the well-known “shared nothing” multi-tenancy model summarized above.

By using a user specific launch configuration, U.S. Pat. No. 8,560,699 (which is hereby incorporated by reference herein in its entirety) describes a technique able to start new instances of a service (e.g., a database service) that is customized to fit the needs of a particular user. In its process, a launch configuration may be provided by the user or may be generated automatically by the system. This is a provisioning-centric approach covering new instances. It does not describe a way of bootstrapping new repositories without user interaction on an already running database instance, however.

It therefore will be appreciated that it would be desirable to solve one or more of the above-described and/or other problems. For example, it will be appreciated that it would be desirable to provide an approach for dynamically setting up and configuring data repository connectivity in a multi-tenant web application, on demand and at runtime.

An aspect of certain example embodiments relates to techniques for dynamically setting up and configuring data repository connectivity in a multi-tenant web application, on demand and at runtime, e.g., in a cloud computing and/or other highly distributed and scalable environment.

Another aspect of certain example embodiments relates to setting up and configuring data repositories while avoiding manual and/or external scripting approaches, and potentially in the absence of detailed knowledge about the requests of the client applications.

Another aspect of certain example embodiments relates to looking up the location of an already existing repository or, in case one does not exist, creating a new repository including all needed technical enhancements (such as, for example, search indexes, etc.), in order to provide a scalable, flexible, and fault tolerant arrangement suitable for use in a highly distributed and scalable environment such as what might be present in connection with a public and/or private cloud environment.

Certain example embodiments thus relate to techniques for dynamically bootstrapping repositories or databases for newly created tenants at runtime in scalable, distributed multi-tenant environments. In certain example embodiments, the bootstrapping is triggered dynamically the first time a client application tries to access a specific repository related to a newly created tenant at runtime, leading to a flexible approach for enabling tenant- and application-specific repositories with optional search index mapping.

The term “bootstrapping” is used herein and, as will be appreciated by those skilled in the art, it oftentimes is used generally to refer to the starting of a self-sustaining process that is supposed to proceed without external input. In this context, however, those skilled in the art will further understand that bootstrapping may relate to the basic configuration of repositories, indexes, tables, views, and/or other components, that might be used in a multi-tenant, potentially highly-distributed and scalable environment (such as a cloud computing environment), e.g., where an application (e.g., a web application) accesses a database or other repository.

Certain example embodiments create structured repositories (e.g., databases) for new tenants dynamically at runtime, with the repository being modeled in means other than the tabular relations used in relational databases such as a “Not only SQL” or NoSQL database. The creation of the repositories may be carried out by a web application or the like and, apart from or in addition to the creation of repositories, certain example embodiments may also involve the dynamic creation of a search index linked to the newly created repositories. Certain example embodiments may undertake like actions in connection with the deletion of a tenant (e.g., when a customer's contract with an application provider ends, etc.).

In certain example embodiments, there is provided a method of managing a distributed, multi-tenant computing system comprising at least one processor and non-transitory storage media hosting a plurality of repositories designated for different respective computing system application-tenant combinations. A request for data to be obtained using a computing system application is received from a client application running on a client device, with the request being associated with a requesting computing system application-tenant combination that is based on a requesting tenant associated with the client application and the computing system application to be used in obtaining the data. A determination is made, using the computing system, as to whether the non-transitory storage media already stores a repository designated for the requesting computing system application-tenant combination. In response to a determination that there already is a repository designated for the requesting computing system application-tenant combination, the request for data is handled using the already existing repository designated for the requesting computing system application-tenant combination. In response to a determination that there is no existing repository designated for the requesting computing system application-tenant combination: a new repository designated for the requesting computing system application-tenant combination is dynamically and automatically created at runtime, without having to restart the computing system; the new repository is dynamically and automatically configured at runtime, without having to restart the computing system; and the request for data is handled using the new repository following said dynamic and automatic configuring.

In certain example embodiments, a distributed, multi-tenant computing system is provided. Processing resources include at least one processor, and are configured to enable a plurality of computing system applications to be performed. Non-transitory storage media hosts a plurality of repositories designated for different respective computing system application-tenant combinations. Wherein the computing system is configured to at least: receive, from a client application running on a client device, a request for data to be obtained using at least one of said computing system applications, the request being associated with a requesting computing system application-tenant combination corresponding to a requesting tenant associated with the client application and the computing system application(s) to be used in obtaining the data; determine whether the non-transitory storage media already stores a repository designated for the requesting computing system application-tenant combination; in response to a determination that there already is a repository designated for the requesting computing system application-tenant combination, handle the request for data using the already existing repository designated for the requesting computing system application-tenant combination; and in response to a determination that there is no existing repository designated for the requesting computing system application-tenant combination (a) dynamically and automatically create and configure, at runtime, a new repository designated for the requesting computing system application-tenant combination, without having to restart the computing system and without having to restart the computing system application(s) to be used in obtaining the data, and (b) handle the request for data using the new repository following said dynamic and automatic configuring.

In certain example embodiments, a distributed, multi-tenant computing system is provided and comprises processing resources including at least one processor. Tenant installations are backed by virtual and/or physical machines and are designated for respective tenants, with each said tenant installation supporting at least one application and at least one repository accessible by and/or to the respective tenant, and with each said repository being designated for a different application-tenant combination. A web application or service is configured to receive a request for a document from a client application. The processing resources cooperate to provide to the web application or service a response to the request for the document from the client application such that: when a determination is made that there is a repository already in existence for the specific combination of the tenant and the application involved in the request, that repository is used in responding to the request; and when a determination is made that there is not a repository already in existence for the specific combination of the tenant and the application involved in the request, a new repository is generated in cooperation with the processing resources dynamically and at computing system runtime, bootstrapping is performed for configuring the new repository dynamically and at computing system runtime, and that new repository is used in responding to the request.

Non-transitory computer readable storage mediums tangibly storing instructions for performing the above-summarized and/or other methods also are provided by certain example embodiments, as well as corresponding computer programs.

These features, aspects, advantages, and example embodiments may be used separately and/or applied in various combinations to achieve yet further embodiments of this invention.

### BRIEF DESCRIPTION OF THE DRAWINGS

These and other features and advantages may be better and more completely understood by reference to the following detailed description of exemplary illustrative embodiments in conjunction with the drawings, of which:

FIG. 1 is an example single-tenancy architecture;

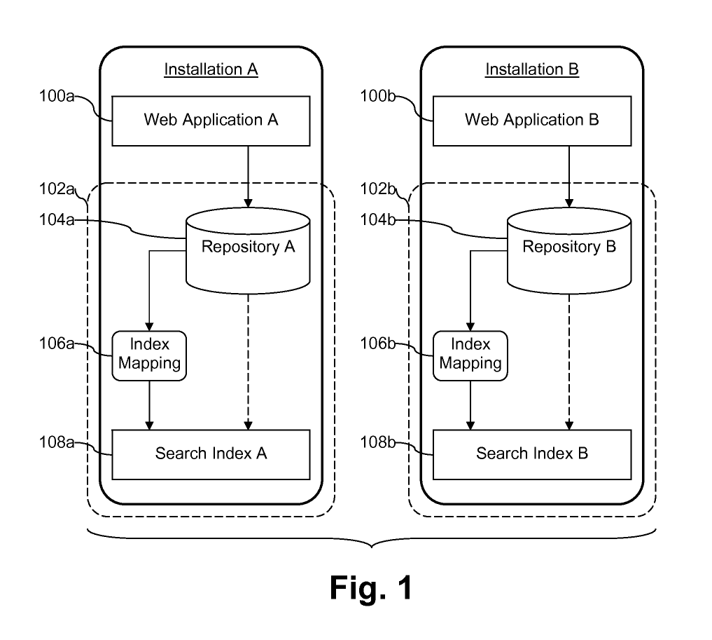

FIG. 2 is a block diagram schematically demonstrating issues that can arise in connection with highly-distributed, multi-tenant scenarios;

FIG. 3 is a block diagram showing example components that may be used in certain example embodiments;

FIG. 4 is a flowchart showing an example process that may be used in connection with certain example embodiments;

FIG. 5 is a more detailed block diagram showing bootstrapping techniques that may be used in connection with certain example embodiments; and

FIG. 6 is a more detailed flowchart showing bootstrapping techniques that may be used in connection with certain example embodiments.

### DETAILED DESCRIPTION OF EXAMPLE EMBODIMENTS

Certain example embodiments use a bootstrapping technique to dynamically instantiate and configure repository (e.g., database) connectivity for a multi-tenant application (e.g., web application) on demand at runtime, e.g., in a highly distributed environment such as a cloud computing environment. The example techniques set forth herein provide a scalable and efficient solution that also is fault tolerant, in certain example implementations. In certain example embodiments, the bootstrapping is triggered dynamically the first time a client application tries to access a specific repository related to a newly created tenant at runtime, leading to a flexible approach for enabling tenant- and application-specific repositories with optional search index mapping.

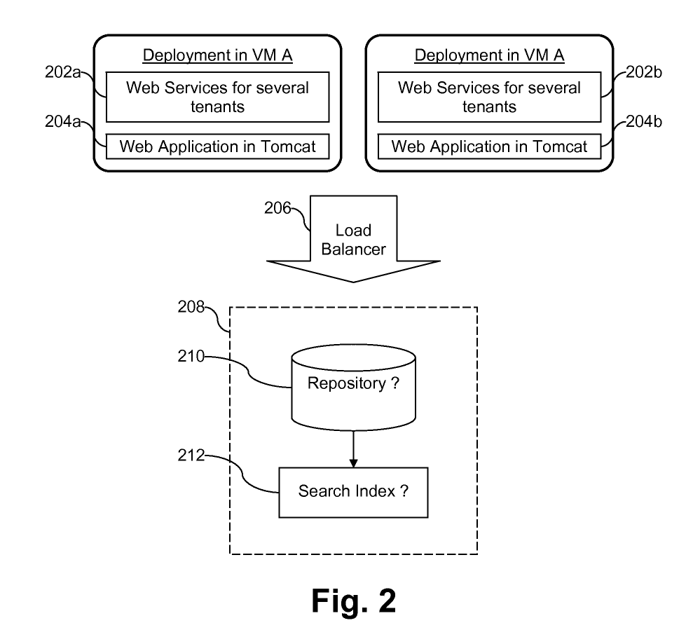

Referring now more particularly to the drawings in which like reference numerals indicate like components throughout the several views, FIG. 2 is a block diagram schematically demonstrating issues that can arise in connection with highly-distributed, multi-tenant scenarios. FIG. 2 shows two virtual machine deployments. Virtual Machine A includes web services 202a that may be used for several tenants, as well as a web application instance (e.g., in Apache Tomcat) 204a. Similarly, Virtual Machine B includes web services 202b that may be used for several tenants, as well as a web application instance (e.g, in Tomcat) 204b. However, when an application instance is dynamically deployed in virtual or physical machine (e.g., Virtual Machines A and/or B in FIG. 2), the specific settings for all services (e.g., the connection settings to the database that will be used, the name of the repository to be references, the index name to be consulted, etc.) may not be known in advance, e.g., if the environment uses several repositories for different tenants and applications.

The main application therefore may need to handle, on-demand and at runtime, several tenants with different web application instances 204a and 204b. Thus, new repositories, etc., may need to be created and configured on-the-fly.

To find a specific database and get the connection details, a registration service may be consulted directly, e.g., if a server-side application is being used by the web application instances 204a and/or 204b. If the request comes from a remote client application that is not integrated into the ecosystem, for example, a load balancer 206 may be provided. The load balancer 206 may help lead to an instance or installation that can handle the request. The web application server thus may query the registry service, directly or indirectly, to determine which, if any, running instances of the database fit to the application/tenant combination being used.

A static repository may not be possible under these circumstances. Instead, on-demand, dynamical reactions to new applications or tenants that come into play at a certain time may be needed, e.g., to bring online and/or access a new instance 208 that includes a new permanent and/or other repository 210 in that new instance 208. The same is true when it comes to accessing a search index. That is, a static search index may not be possible, and instead a new search index 212 that corresponds with the new permanent repository 210 that has been created may be created.

Certain example embodiments thus respond to the issues raised in connection with FIG. 2. That is, because bootstrapping at startup may not be possible, certain example embodiments provide the ability to dynamically create at runtime new repositories for new tenants and for several applications. Furthermore, because index mapping for a search engine or other feature may not be provided in advance, in addition or in the alternative, certain example embodiments provide the ability to create indices for new repositories on-the-fly, e.g., to make the repository searchable.

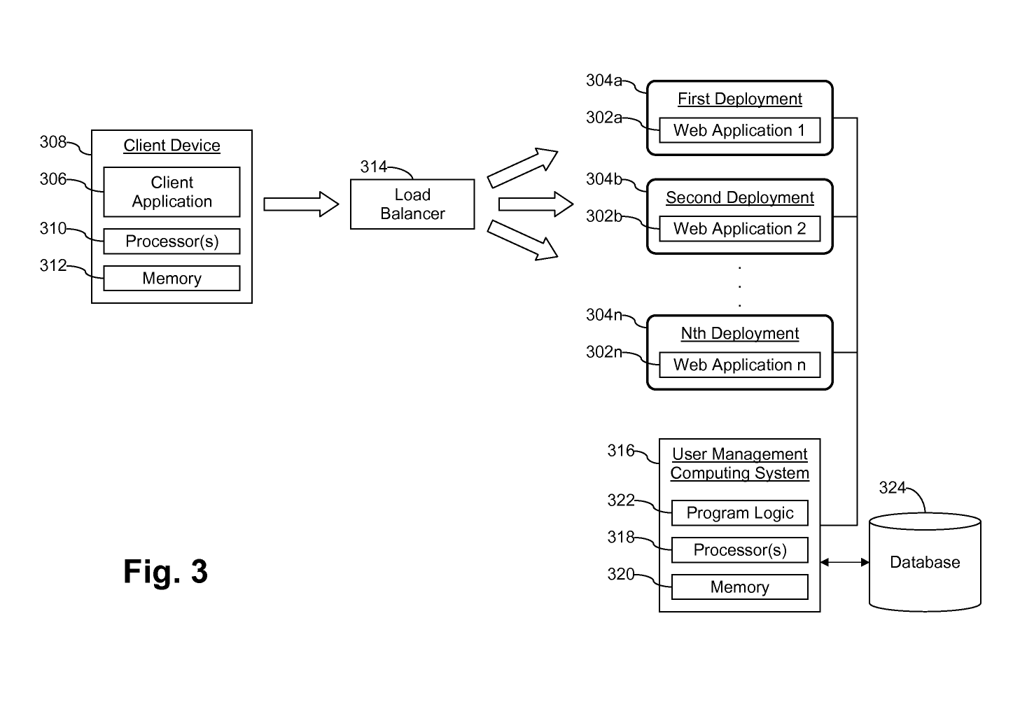

FIG. 3 is a block diagram showing example components that may be used in certain example embodiments. Having several web applications 302a-302n deployed in distinct virtual or physical machines 304a-304n, a running instance would be selected for the client application 306 running on the client computing device 308 (which may include processing resources such as, for example, at least one processor 310 and a memory 312). This selection may be performed using a load balancer 314 or, alternatively, it may be directly chosen, e.g., if the client application 306 is a server-side web application within the same ecosystem. Following the selection, determinations are made as to who the tenant is who is trying to access a repository, and which client application the request is coming from (e.g., via a provisioning and/or user management computing system 316 that includes at least one processor 318a memory 320 and program logic 322 in communication with the deployments 304a-304n). With this information, a lookup at the database 324 is initiated to determine whether a repository already exists and is available for the combination of the tenant and application for which it is to be used. The database 324 and repositories may, of course, be hosted on a computing system that includes transitory and/or non-transitory media, and the database 324 may be queried by the provisioning and/or user management computing system 316, etc. The database 324 may be database that supports SQL queries, it may be a NoSQL database, etc. The deployments 304a-304n may be supported in a cloud computing environment, e.g., where there is a processing system including at least one processor, a memory, storage, and/or the like, on one or more nodes that may or may not be distributed in different implementations.

Certain example embodiments may use a pattern or other naming scheme for identifying the correct repository. The pattern may comprise or consist of the following and/or other example information: the type of the storage (e.g., temporarily or permanent), the application acronym or other identifier, and the tenant ID. For instance, if there is an attempted accession via a tenant “tenant1” and an application “app1”, then a unique key would be created for the repository using this information. An attempt to access the repository would be made and, if the attempt fails, a repository with the generated key would be created. In this example, the pattern generated has the following format: “permanent_app1_tenant1”.

Determining whether a newly created repository needs a search index may be performed by the first section of the pattern. For instance, if the pattern contains the string “permanent,” it will be available for searching. In that case, an index mapping may be created. The name of this mapping may be made unique by using the same, similar, or different structure for the name of the index as the name of the repository. The name may be unique and refer directly to this exact repository. Thus, it will be appreciated that the same structure may, for example, be used for repository naming and index naming, so both the index and the repository could be called “permanent_app1_tenant1”. Alternative, or in addition, a similar structure could be used such that the mapping is called “permanent_app1_tenant1_mapping”, or the like. Such functions may be undertaken by the provisioning and/or user management computing system 316, e.g., in cooperation with the database 324 and the newly created repository.

Such techniques are advantageous because they may in certain example embodiments enable the web application to scale at runtime, replicate it without significant downtimes, provide a fault tolerant system, and/or the like, even if new repositories need to be created at runtime for newly created tenants and/or new applications that will make use of the web application.

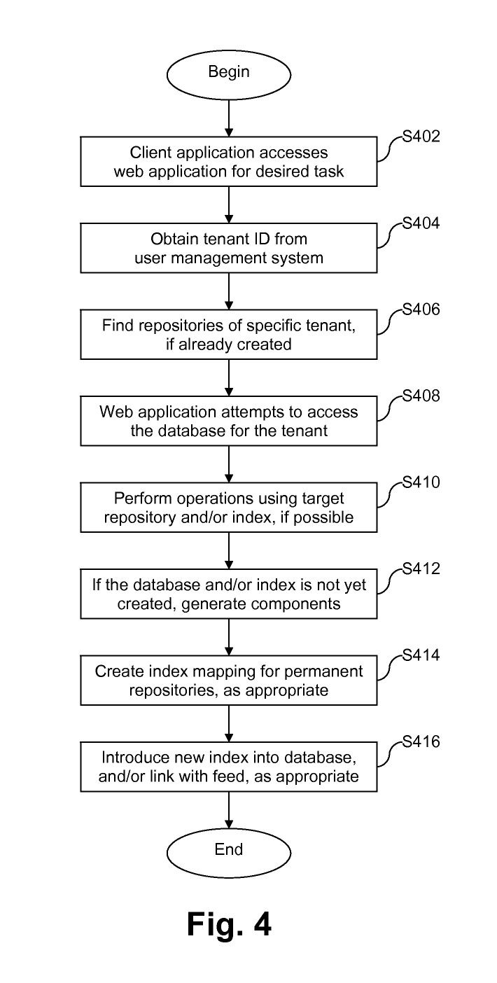

FIG. 4 is a flowchart showing an example process that may be used in connection with certain example embodiments. In step S402, a client application accesses a web application to perform a desired task. The task might be anything and may involve, for example, uploading or downloading data and/or a document. To perform that operation, the web application obtains a tenant ID that may be retrieved from, for example, a user management system or the like, e.g., in step S404. If the user from which this request comes from belongs to a tenant that has not already been created, then the example techniques described herein may come into play and the attendant advantages realized. With this information, in step S406, the location of the database server is obtained from the registry where all running services may be listed, e.g., to find the repositories of this specific tenant, assuming that they have already been created.

Now that a server location on which the database (e.g., a NoSQL document oriented database) runs is known, the web application can attempt to access the database for the tenant in step S408. If the database with the ID described above already exists, the process is ended and the desired operation can take place (e.g., the web application can write or retrieve the requested data, etc.). Similar operations take place if a search is being made for a document. That is, if an index has already been created, the web application can search the index and retrieve the result set from the database. Thus, as shown in step S410, the desired operations are performed with respect to the target repository and/or index, if possible, and the FIG. 4 process may be ended.

On the other hand, if the database and/or index is/are not yet created, the components deemed necessary may be created in step S412. This may involve, for example, the generation of a repository ID for the new database as described above, the creation of repository, the registration of the newly created repository with the database and/or registry, etc. If the repository is of type “permanent,” step S414 involves the creation of an index mapping for the search engine. The name of the index may have the same or similar naming convention as the repository ID in certain example implementations. After creating the index, it may be introduced into the database with a search plug-in, it may be linked to the corresponding changes feed of the newly created repository, etc., in step S416. It will be appreciated that a changes feed in certain example embodiments automatically provide information about changes in the repository and, thus, this functionality may be used to update a search index automatically by listening to the feed instead of polling or pushing the data to search index, for example.

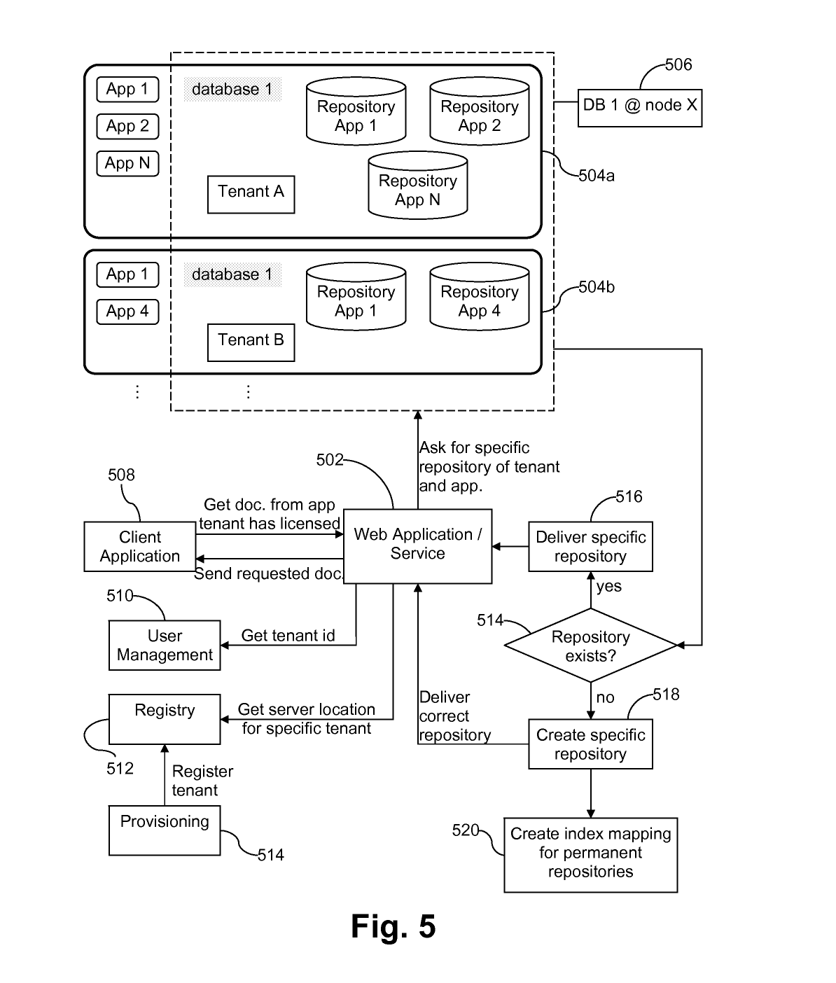

FIG. 5 is a more detailed block diagram showing bootstrapping techniques that may be used in connection with certain example embodiments. In a highly-distributed environment, there are several applications that use the illustrative web application or service 502. The applications are identified in FIG. 5 as Apps 1, 2, 4, and n, although others may be provided. There is not a single, one application that can be statically configured to use the web application or service 502 in the FIG. 5 example. Moreover, in this example, the highly-distributed environment is a cloud computing environment, and the web application or service 502 is provided for performing document storage operations.

In FIG. 5, first and second installations 504a-504b are shown for Tenants A and B, respectively. Each of Tenants A and B has licensed several applications in the ecosystem. Each installation includes at least one repository for every application used by the tenant associated with that installation, and this relationship may hold true for all tenants that are available at present and/or will be present at a time in the future.

Because of this relationship, it is possible to use one database (e.g., one NoSQL database) at one node 506 to handle several tenants and all of their respective applications. It will be appreciated that the node 506 may be a physical node or backed by a virtual machine or the like. If new capacity is needed, it is possible to add a new node and begin creating new repositories for new tenants, replicating a repository to a new database, etc., e.g. if the data or traffic of one tenant cannot be handled by a single node any longer.

The above-described relationship holds true for the other tenants in the system. For instance, Tenant B has its own repositories and can be run on the same node 506 as Tenant A.

When a client application 508 (which may in certain example embodiments be a server-side application, a remote client application, and/or the like) tries to download or upload a document to the web application or service 502, an attempt is made to retrieve the document from a specific application that the corresponding tenant has licensed. In this regard, the web application or service 502 attempts to determine where the document might be found or might need to be stored.

To compile the repository ID, certain information is gathered. This may include, for example, the tenant ID of the user the request comes from, in addition to already-available information including the application type or acronym, the repository type (e.g., permanent or temporary), and the user token itself. The tenant ID, for example, can be retrieved from the user management system 510. The location where the database and the search engine run and retrieve the information from may be obtained from the registry service 512. This information may be provided by a provisioning tool 514, which helps provide these settings, as new instances are created. The information that is provided may include, for example, an absolute or relative path in a file system, a URL, a GUID, a UUID, and/or the like. The provisioning tool 514 may in certain example embodiments alternative or additionally be used to set up and maintain the entire environment (or at least parts thereof), e.g., to startup new database instances, register tenants, etc.

Once this information is known, the web application or service 502 tries to connect to exactly that specific repository at the database node 506 that was retrieved from the registry service 512. It also determines if the repository has already been created and is available on this node. To achieve this, a request is made to the database and a check as to whether the repository exists is made (e.g., in decision block 514). If the repository already exists, it can be retrieved and delivered to the web application or service 502 by requesting it directly, e.g., as indicated by block 516. With that already-existing repository, the web application or service 502 can store or access the requested document on this database instance.

On the other hand, if decision block 514 determined that the repository does not yet exist, it will be created with the specific ID, e.g., as indicated in block 518. If the repository is a “permanent” type repository, an index will be created as indicated in block 520. The index may be named with the same or similar pattern already used to create the repository ID. This approach is advantageous in certain example embodiments, e.g., in that it is feasible to connect this index via a changes feed to the corresponding repository, to keep it up-to-date, and to identify it easily when search requests arrive at the application server. The newly created repository is then directly available in the application server and can be used for further requests, the initial request now being completed.

After the computation within the application server on the specific repository (regardless of whether it is preexisting or newly created), the document can be delivered to or uploaded from the client application 508, e.g., as appropriate.

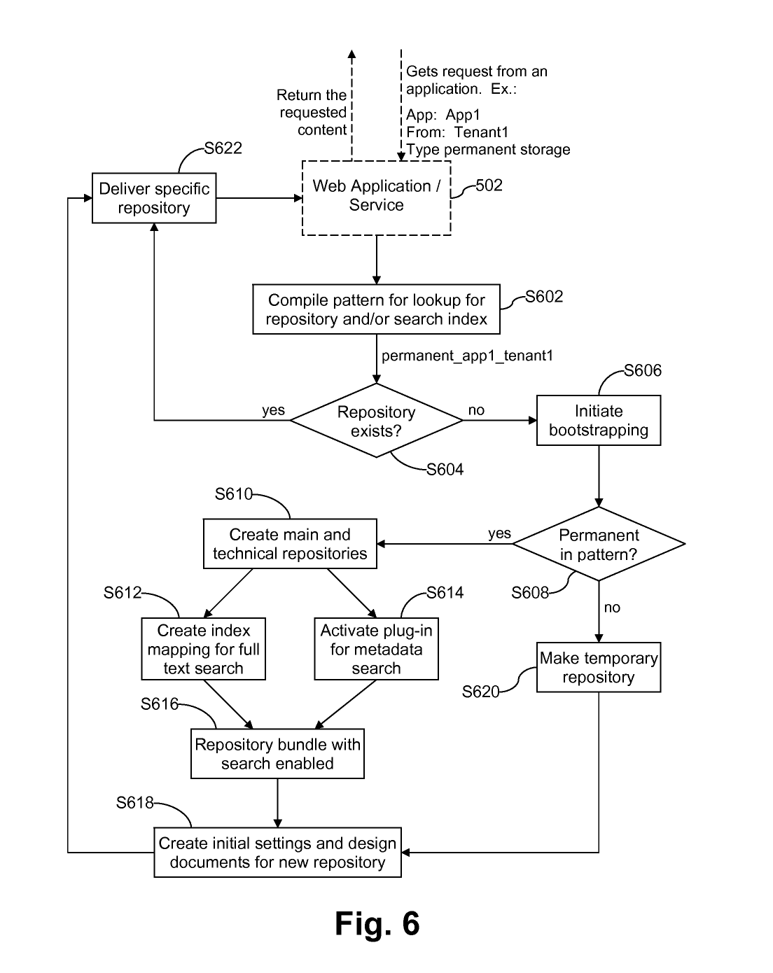

FIG. 6 is a more detailed flowchart showing bootstrapping techniques that may be used in connection with certain example embodiments. The FIG. 6 example process starts when the web application or service 502 receives a request from another application. In the illustrated example, the application is designated “app1” and comes from a user that belongs to a specific tenant called “tenant1”. The type of the requested document is of type “permanent” storage. The web application or service 502 compiles this information in step S602 using the predefined pattern format and, in this example, the pattern “permanent_app1_tenant1” is generated. The generated pattern now can be used for a lookup operation. A determination is made in step S604 as to whether the repository including all technically related repositories, configurations, index mappings, and/or the like already exists. If the repository already exists, the connection details and so on are delivered to the service layer that is responsible for retrieving and processing the data, e.g., so that the desired information can be operated on. Step S602 states “Compile pattern for lookup for repository and/or search index” and, thus, it will be appreciated that the example techniques discussed herein may be used in connection with looking up a search index. It will be appreciated that this may be accomplishing in a similar manner to that described herein (although minor modifications may apparent to those skilled in the art could be implemented, e.g., if there were already a repository and only an index needed to be created, other bootstrapping processes were leveraged, etc.).

If the repository does not exist, bootstrapping is triggered in step S606, with all of its associated technical implications. A check is made in step S608 as to whether the already-compiled repository pattern contains the string “permanent.” All technically related processes that are needed for further operations may also be prepared, e.g., as discussed above. One example could b the lookup or creation of a search index.

If the repository pattern contains the string “permanent”, the actual main repository and the related technical repositories are created in step S610. In this example situation, one repository is created for the configuration settings of exactly this tenant, and one repository that contains already-computed links for accessing special data via a HTTP client, like a web browser, is created as well.

The main repository may need to be searchable. This may be expressly specified, or inferred from the presence of the string “permanent” in its ID. For instance, in this example scenario, it might be desirable to be able to search for metadata of all stored documents or files. Similarly, it might be desirable to perform a full-text search for text documents that satisfy specific criteria, like “has to be a file of type PDF or plain text and doesn't exceed the maximum file size for the indexation”, etc. Thus, after creating the index mapping for the full text search, it might be desirable to ensure that metadata also is searchable. These operations for setting up such searches are shown in FIG. 6 in connection with step S612.

To enable searches in the metadata of the stored files, step S614 involves configuring and activating a search plug-in for the search engine. The search plug-in may be directly connected to the database in certain example embodiments. To keep the index up to date in real-time, the plug-in may be correctly configured and connected to the changes feed of the database or, more precisely, connected to the corresponding database instance that is elected to handle the data of the current tenant. For instance, as indicated above, connection to a changes feed may be a part of the technical preparation for automatic configuration of a searchable repository, and it thus could in some implementations be a further example of the technical needs for an example bootstrapping process.

Once steps S612 and S614 are taken, the repository bundle with the search is enabled in step S616. It also now becomes possible to update the information in the registry service with the changes to the assignments of this tenant and prepare the newly created repositories with their initial settings, e.g., as shown in step S618. The new permanent repository is provided with already stored data and/or is formatted appropriately, e.g., at the time a user of a newly created tenant accesses it. For example, a root folder may be established, and a design documents for the view that will be created on demand may be stored therein. It will be appreciated that a design document can be any document that is required to be able to use the repository such as, for example, a configuration file, JavaScript snippet used to query data comparable to a stored procedure in an RDBMS, etc. After everything needed is created at runtime, this root folder can be created and the design documents for all newly created repositories can be saved thereto.

Referring once again to the decision made in step S608, if the repository pattern does not contain the string “permanent”, only the repository is created, e.g., for temporary storage, in step S620. Step S618 then performs the appropriate configuration for the newly created temporary repository. It will be appreciated that the implementation details might be altered in some cases, as between permanent and temporary repositories. For example, as alluded to here, there typically is not a search index for the temporary repository, the number and/or type of design documents may differ, etc.

In step S622, the information about the requested repository is returned to the service layer of the web application or service 502 to process and send or retrieve the data. Finally, the content is returned to the client application from the web application or service 502, and the process ends.

The techniques of certain example embodiments are able to react dynamically to newly created tenants and are able to scale horizontally and use available resources very efficiently. That is, certain example embodiments advantageously enable horizontal scaling by making use of additional database instances that may deployed by a provisioning tool or the like, on demand. Thus, certain example embodiments are not necessarily limited to a fixed number of tenants or repositories and can distribute data (potentially equally) across instances. Indeed, it may be possible in certain example embodiments to directly access the repository for new tenants or new applications that will eventually come into play without taking down the server infrastructure. It follows that the server infrastructure of certain example embodiments is more failsafe and overall availability is improved.

Although certain example embodiments have been described in connection with having several web applications 302a-302n deployed in distinct virtual or physical machines 304a-304n, it will be appreciated that certain implementations may implement multiple web applications on a single virtual or physical machine, one application across one or more virtual or physical machines, etc.

It will be appreciated that as used herein, the terms system, subsystem, service, engine, module, programmed logic circuitry, and the like may be implemented as any suitable combination of software, hardware, firmware, and/or the like. It also will be appreciated that the storage locations herein may be any suitable combination of disk drive devices, memory locations, solid state drives, CD-ROMs, DVDs, tape backups, storage area network (SAN) systems, and/or any other appropriate tangible non-transitory computer readable storage medium. Cloud and/or distributed storage (e.g., using file sharing means), for instance, also may be used in certain example embodiments. It also will be appreciated that the techniques described herein may be accomplished by having at least one processor execute instructions that may be tangibly stored on a non-transitory computer readable storage medium.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A method of managing a distributed, multi-tenant computing system comprising at least one processor and non-transitory storage media hosting a plurality of repositories designated for different respective computing system application-tenant combinations, the method comprising:
receiving, from a client application running on a client device, a request for data to be obtained using a computing system application, the request being associated with a requesting computing system application-tenant combination that is based on a requesting tenant associated with the client application and the computing system application to be used in obtaining the data;
determining, using the computing system, whether the non-transitory storage media already stores a repository designated for the requesting computing system application-tenant combination;
in response to a determination that there already is a repository designated for the requesting computing system application-tenant combination, handling the request for data using the already existing repository designated for the requesting computing system application-tenant combination; and
in response to a determination that there is no existing repository designated for the requesting computing system application-tenant combination:
dynamically and automatically creating at runtime a new repository designated for the requesting computing system application-tenant combination, without having to restart the computing system,
dynamically and automatically configuring the new repository at runtime, without having to restart the computing system, and
handling the request for data using the new repository following said dynamic and automatic configuring.

2. The method of claim 1, wherein the determining is performed in connection with a naming scheme.

3. The method of claim 2, wherein each said repository has a unique name by virtue of the naming scheme.

4. The method of claim 2, wherein the naming scheme produces unique keys usable by the computing system application to access and/or determine the existence of the respective repositories, each said key being based on an indication of a way in which the respective repository is to be stored, an application identifier, and a tenant identifier.

5. The method of claim 4, wherein permissible ways in which the repositories are storable include permanent and temporary storage types.

6. The method of claim 1, wherein permissible ways in which the repositories are storable include permanent and temporary storage types.

7. The method of claim 6, wherein the response to the determination that there is no existing repository designated for the requesting computing system application-tenant combination further comprises creating a new search index mapping, provided that the new repository is a permanent storage type repository.

8. The method of claim 7, wherein created search index mappings are named and/or addressable using the same naming scheme as that used for the respective repositories.

9. The method of claim 7, further comprising connecting the new search index mapping to a changes feed from the corresponding repository to enable continuous updating of the search index mapping.

10. The method of claim 1, further comprising when the client application is a server-side application, relaying from a registry server to the client application an indication as to whether the non-transitory storage media already stores a repository designated for the requesting computing system application-tenant combination in response to a direct query from the client application to the registry server.

11. The method of claim 1, further comprising at least when the client device is external to the computing system's ecosystem, relaying from a registry server to the client application an indication as to whether the non-transitory storage media already stores a repository designated for the requesting computing system application-tenant combination in response to a query from the client application to the registry server made via a load balancer.

12. The method of claim 1, wherein the computing system application is a web application.

13. The method of claim 1, wherein at least some of the repositories are NoSQL databases.

14. A distributed, multi-tenant computing system, comprising:
processing resources including at least one processor and configured to enable a plurality of computing system applications to be performed; and
non-transitory storage media hosting a plurality of repositories designated for different respective computing system application-tenant combinations;
wherein the computing system is configured to at least:
receive, from a client application running on a client device, a request for data to be obtained using at least one of said computing system applications, the request being associated with a requesting computing system application-tenant combination corresponding to a requesting tenant associated with the client application and the computing system application(s) to be used in obtaining the data;
determine whether the non-transitory storage media already stores a repository designated for the requesting computing system application-tenant combination;
in response to a determination that there already is a repository designated for the requesting computing system application-tenant combination, handle the request for data using the already existing repository designated for the requesting computing system application-tenant combination; and
in response to a determination that there is no existing repository designated for the requesting computing system application-tenant combination: (a) dynamically and automatically create and configure, at runtime, a new repository designated for the requesting computing system application-tenant combination, without having to restart the computing system and without having to restart the computing system application(s) to be used in obtaining the data, and (b) handle the request for data using the new repository following said dynamic and automatic configuring.

15. The system of claim 14, wherein the repositories are accessible via a naming scheme.

16. The system of claim 15, wherein the naming scheme produces unique keys usable by the computing system applications to access the repositories and/or determine whether individual ones of the repositories exist, each said key being based on (a) an indication of a way in which the respective repository is to be stored, (b) an application identifier, and (c) a tenant identifier.

17. The system of claim 14, wherein permissible ways in which the repositories are storable include permanent and temporary storage types.

18. The system of claim 17, wherein the response to the determination that there is no existing repository designated for the requesting computing system application-tenant combination further involves creating a new search index mapping, provided that the new repository is a permanent storage type repository.

19. The system of 18, wherein at least some of the repositories are configured to generate a changes feed, and wherein search index mappings are connectable to changes feeds from corresponding repositories to enable updating of the search index mappings.

20. The system of claim 14, further comprising a registry server that is configured to:
(a) accept a direct query from the client application as to whether the non-transitory storage media already stores a repository designated for the requesting computing system application-tenant combination and provide a response thereto, provided that the client application is a server-side application, and
(b) respond to a query from the client application to the registry server made via a load balancer as to whether the non-transitory storage media already stores a repository designated for the requesting computing system application-tenant combination, at least when the client device is external to the computing system.

21. The system of claim 14, wherein the computing system application is a web application and at least some of the repositories are NoSQL databases.

22. At least one non-transitory computer readable storage medium tangibly storing instructions that are performable to accomplish at least the method of claim 1.

23. A distributed, multi-tenant computing system, comprising:
processing resources including at least one processor;
a plurality of tenant installations backed by virtual and/or physical machines and designated for respective tenants, each said tenant installation supporting at least one application and at least one repository accessible by and/or to the respective tenant, each said repository being designated for a different application-tenant combination; and
a web application or service configured to receive a request for a document from a client application;
wherein the processing resources cooperate to provide to the web application or service a response to the request for the document from the client application such that:
when a determination is made that there is a repository already in existence for the specific combination of the tenant and the application involved in the request, that repository is used in responding to the request; and
when a determination is made that there is not a repository already in existence for the specific combination of the tenant and the application involved in the request, a new repository is generated in cooperation with the processing resources dynamically and at computing system runtime, bootstrapping is performed for configuring the new repository dynamically and at computing system runtime, and that new repository is used in responding to the request.

24. The system of claim 23, further comprising:
a user management subsystem configured to provide to the web application or service a tenant identifier for the tenant associated with the client application;
a registry configured to provide to the web application or service a server location for the tenant associated with the client application; and
a provisioning subsystem configured to register tenants with the registry.

25. The system of claim 23, wherein:
the repositories are accessible via a naming scheme that produces unique keys usable in accessing the repositories and/or determining whether they exist, each said key being based on (a) an indication of a way in which the respective repository is to be stored, (b) an application identifier, and (c) a tenant identifier;
permissible ways in which the repositories are storable include permanent and temporary storage types;
the processing resources further cooperate to provide to the web application or service a response to the request for the document from the client application such that when the determination is made that there is not a repository already in existence for the specific combination of the tenant and the application involved in the request, a new search index mapping is created, provided that the new repository is a permanent storage type repository and not a temporary storage type repository; and
the naming scheme also is used for search index mappings.
